(19) United States
(12) Patent Application Publication
(10) Pub. No.: US 2014/0248016 A1
(43) Pub. Date: Sep. 4, 2014

(54) COMPOSITE ANNULAR SEAL ASSEMBLY FOR BEARINGS

(71) Applicant: Roller Bearing Company of America, Inc., Oxford, CT (US)

(72) Inventor: Alex Habibvand, Orange, CA (US)

(73) Assignee: ROLLER BEARING COMPANY OF AMERICA, INC., Oxford, CT (US)

(21) Appl. No.: 14/194,016

(22) Filed: Feb. 28, 2014

Related U.S. Application Data
(60) Provisional application No. 61/771,214, filed on Mar. 1, 2013.

(51) Int. Cl. F16C 33/76

(52) U.S. Cl. CPC F16C 33/767
USPC 384/482

(57) ABSTRACT

A seal for a bearing includes a first annular retaining ring defining a first radially outermost portion and a second annular retaining ring defining a second radially outermost portion. The seal includes a resilient ring defining a third radially outermost portion. The resilient ring is disposed between the first annular retaining ring and the second annular retaining ring. The first radially outermost portion, the second radially outermost portion and the third radially outermost portion are aligned with one another. The resilient ring projects radially inward from the first annular retaining ring and the second annular retaining ring. The resilient ring is more compressible and flexible than the first annular retaining ring and the second annular retaining ring.

### CROSS REFERENCE TO RELATED APPLICATIONS

This application claims priority to U.S. Provisional Patent Application Ser. No. 61/771,214, entitled “Sandwich Seal Design for Hourglass Roller Bearing,” and filed Mar. 1, 2013, the subject matter of which is incorporated herein by reference.

### FIELD OF THE INVENTION

The present invention relates generally to a composite seal for use in bearings and more particularly to a composite annular seal assembly having a resilient ring disposed between (e.g., sandwiched between) two annular retaining rings, for use in bearings.

### BACKGROUND OF THE INVENTION

There are many types of bearings that are used in various applications. Such bearings include journal bearings, roller bearings, spherical bearings and hourglass type bearings. In general, these bearings have an inner race that is disposed at least partially in an outer race. The inner race and outer race are movable relative to one another. There is an annular cavity between the inner race and the outer race that typically contains a lubricant. One well known problem with bearings is the ingress of debris and contaminants into the annular cavity which can cause premature failure of the bearings due to degradation of the lubrication. Moreover, operation of the bearing can cause the lubricant to inadvertently escape from the annular cavity.

In an effort to mitigate the aforementioned problems, seals have been positioned across the annular cavity to maintain the lubricant in the cavity and to prevent the ingress of debris into the annular cavity. However, during operation, such seals become dislodged from the bearing and fail to function. In addition, such seals have often been too flexible, thereby allowing the seal to glide over debris and sweep the debris into the annular cavity.

### SUMMARY OF THE INVENTION

There is disclosed herein a seal for a bearing, such as an hourglass bearing, a journal bearing or a roller bearing. The seal includes a first annular retaining ring which defines a first radially outermost portion and a second annular retaining ring defining a second radially outermost portion. The seal includes a resilient ring defining a third radially outermost portion. The resilient ring is disposed between the first annular retaining ring and the second annular retaining ring. The first radially outermost portion, the second radially outermost portion and the third radially outermost portion are aligned with one another. The resilient ring projects radially inward from the first annular retaining ring and the second annular retaining ring. The resilient ring is more compressible and flexible than the first annular retaining ring and the second annular retaining ring.

There is further disclosed herein a bearing having one or more annular seal assemblies positioned therein. The bearing includes an outer race having a first concave inner surface and an interior area. The bearing further includes an inner race having a convex outer surface. A portion of the inner race is disposed in the interior area. The annular seal assembly is snap-fit into the outer race. The annular seal assembly includes a first annular retaining ring which defines a first radially outermost portion, a second annular retaining ring which defines a second radially outermost portion, and a resilient ring which defines a third radially outermost portion. The resilient ring is disposed between the first annular retaining ring and the second annular retaining ring. The first radially outermost portion, the second radially outermost portion and the third radially outermost portion are aligned with one another. The resilient ring projects radially inward from the first annular retaining ring and the second annular retaining ring. The resilient ring is more compressible and flexible than the first annular retaining ring and the second annular retaining ring.

In one embodiment, the bearing includes a radially inward facing groove formed proximate an axial end of the outer race. The groove is defined by opposing side walls and a base extending between the opposing side walls. The first radially outermost portion, the second radially outermost portion and the third radially outermost portion are seated between the opposing side walls so that the third radially outermost portion is retained between the first radially outermost portion and the second radially outermost portion in response to retention forces applied by the opposing side walls to the first annular retaining ring and the second annular retaining ring.

In one embodiment the retention forces are of a magnitude sufficient to retain the annular seal assembly secured to the outer race upon cyclic angular displacement of the outer race relative to the inner race.

### DESCRIPTION OF THE DRAWINGS

FIG. 1 is a cross-sectional view of a portion of a bearing in accordance with one embodiment of the present invention;

FIG. 2A is an edge view of a composite annular seal assembly for the bearing shown in FIG. 1;

FIG. 2B is a side view of the composite annular seal assembly of the bearing shown in FIG. 2A;

FIG. 3A is an enlarged view of a portion of the composite annular seal of FIG. 1;

FIG. 3B is an enlarged view of another embodiment of the composite annular seal of FIG.1;

FIG. 3C illustrates an alternative to the embodiment of FIG. 3B;

FIG. 4 is a cross sectional view of the bearing of FIG. 1 with the composite seal assembly shown in a laterally deflected state during installation into the bearing; and

FIG. 5 is a cross sectional view of a journal bearing.

### DETAILED DESCRIPTION OF THE INVENTION

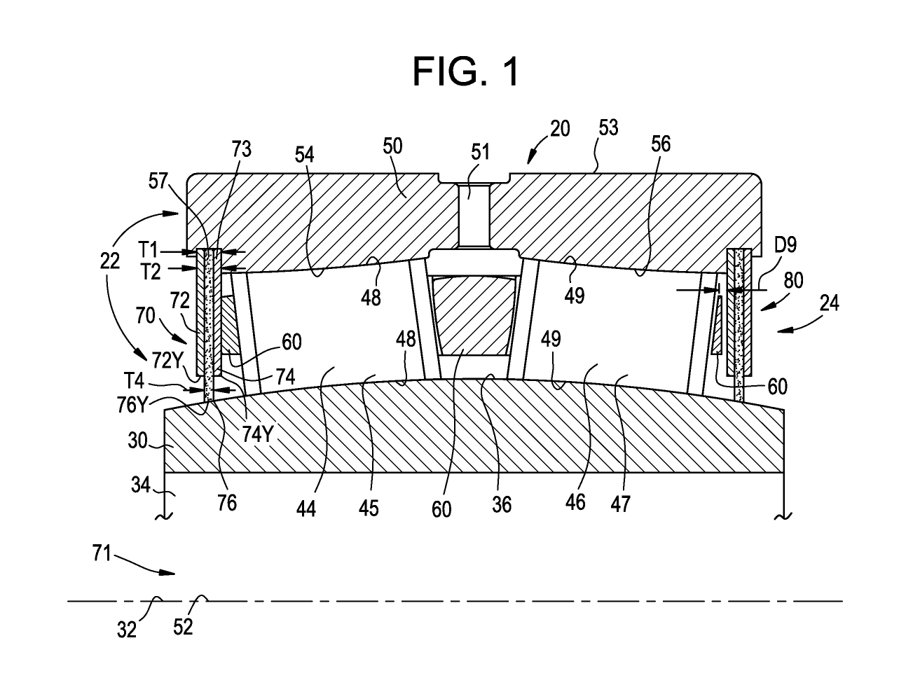

In reference to FIG. 1, a roller bearing apparatus 20 in accordance with the present invention is shown. In the embodiment illustrated in FIG. 1, the bearing 20 is an angular contact self-aligning bearing having hourglass type rollers 45, 47 as described herein. The bearing 20 has a composite annular seal assembly 70 (e.g., a sandwich seal) positioned on opposing ends thereof, as described further herein. The composite annular seal assembly 70 inhibits the ingress of contaminants into internal areas of the bearing 20 and egress of lubricant therefrom, as described herein. While the angular contact self-aligning bearing having hourglass type rollers is shown and described, the present invention is not limited in this regard as the composite annular seal assembly 70 may be employed with any type of bearing including but not limited to rolling bearings having balls and/or rollers, spherical plain bearings and journal bearings (see e.g., FIG. 5).

As shown in FIG. 1, the bearing 20 includes an inner race 30 and an outer race 50. The inner race 30 includes an inner race surface 36. The inner race surface 36 is generally convex. The inner race 30 defines a bore 34 extending therethrough. In some embodiments, the bore 34 may be coaxial with a central axis 32 of the inner race 30. In other embodiments, the bore 34 may be parallel to and radially displaced from the central axis 32 of the inner race 30, i.e. eccentric. A shaft (not shown) may be received in the bore 34. The shaft may be fixed about the central axis 32 relative to the inner race 30 by, for example, an interference fit between the shaft and the bore 34. It should be understood that although an interference fit is described in reference to the embodiment shown in FIG. 1, the present invention is not limited in this regard and the shaft may be fixed relative to the bore 34 of the inner race 30 using other known techniques, including, for example, welding, thermal installation, pinning, or by providing a bore and shaft with similarly shaped angular cross-sections to inhibit rotation slippage. In yet other embodiments, the inner race 30 and the shaft are the same component. In yet other embodiments, the shaft may be rotatable relative to the inner race 30.

The outer race 50 is annular about a central axis 52 of the outer race 50. The central axis 52 is coaxial with the central axis 32 of the inner race 30 when bearing is aligned. It should be understood that the central axis 32 of the inner race 30 and the central axis 52 of the outer race 50 may be parallel and laterally displaced, for example, when the bearing 20 is subject to a radial force.

In the embodiment illustrated in FIG. 1, the outer race 50 defines a first outer race surface 54 and a second outer race surface 56, and each of the first and second outer race surfaces 54, 56 is generally opposite the inner race surface 36. Each of the first and second outer race surfaces 54, 56 is generally convex. The first outer race surface 54 and the inner race surface 36 define a first raceway 44 and the second outer race surface 56 and the inner race surface 36 define a second raceway 46. While the first and second outer race surfaces 54, 56 are shown and described as being generally convex, the present invention is not limited in this regard as in the embodiment shown in FIG. 5 wherein a journal bearing 220 has a concave race surface 254 of the outer race 250 and has a pin 230 with a convex outer race surface 236.

As illustrated in FIG. 1, the bearing 20 also comprises a plurality of first rollers 45 disposed in the first raceway 44, and a plurality of second rollers 47 disposed in the second raceway 46. Each of the plurality of first rollers 45 defines a first concave outer surface 48 that generally conforms to the convex surfaces of the inner race surface 36 and the first outer race surface 54. Each of the plurality of second rollers 47 defines a second concave outer surface 49 that generally conforms to the convex surfaces of the inner race surface 36 and the second outer race surface 56. This type of roller 45, 47 is generally referred to as an hourglass roller because of its generally concave surface extending between its ends. The bearing 20 further includes a cage 60 disposed between the inner race 30 and the outer race 50. The rollers 45, 47 and the cage 60 facilitate rotation of the outer race 50 relative to the inner race 30. The cage 60 also facilitates precessing of the rollers 45, 47 so that each of the rollers 45, 47 cycle through a load zone, even though the bearing 20 may be subject to an oscillatory rotation. Although a cage 60 is shown in the FIG. 1, the present invention is not limited in this regard and a person of ordinary skill in the art and familiar with this disclosure will understand that other known methods of precessing or indexing may be employed.

The outer race 50 defines a circumference 53 which includes a plurality of equally-spaced holes 51 therethrough for receiving a lubricant. The plurality of holes 51 provide fluid communication from an area outside the outer race 50 to a cavity defined by the inner race 30 and outer race 50 and including the first raceway and the second raceway 44, 46. The plurality of holes 51 allow lubricant to be introduced and maintained in the first and second raceways 44, 46.

As shown in FIG. 1, the bearing 20 includes a first composite annular seal assembly 70 at or proximate to a first end 22 of the bearing 20 and a second composite annular seal assembly 80 at or proximate to a second end 24 of the bearing 20. The composite annular seal assemblies 70, 80 facilitate retention of lubricant in the first and second raceways 44, 46 and inhibit the ingress of contaminants into the first and second raceways 44, 46. The first composite annular seal assembly 70 extends from the first outer race surface 54 to the inner race surface 36; and the second composite annular seal assembly 80 extends from the second outer race surface 56 to the inner race surface 36. The composite annular seal assemblies 70, 80 are positioned axially adjacent to the cage 60. In one embodiment as shown with respect to the second composite annular seal assembly 80, the composite annular seal assembly 80 is positioned axially adjacent to the cage 60 and spaced apart therefrom by a distance D9 as shown in FIG. 1. In one embodiment, the composite annular seal assemblies 70, 80 define a substantially flat configuration and are positioned substantially parallel to one another. The disclosed hourglass roller bearing 20 may be subject to oscillatory rotation about its central axis 32, 52. In addition, the bearing 20 is angularly displaceable. For example, the central axis 52 of the outer race 50 may become angularly displaced from the central axis 32 of the inner race 30. To the extent the bearing 20 becomes angularly displaced as a result of an external force, the bearing 20 is configured to self-align. The inventors have discovered that bearing seals currently on the marketplace tend to dislodge or fail when such a bearing is subject to such angular displacement. The inventors have discovered that the composite annular seal assembly 70, 80 disclosed in the present application overcomes one or more of these problems associated with known seals, and is better capable of retaining its position when the bearing is subject to angular displacement.

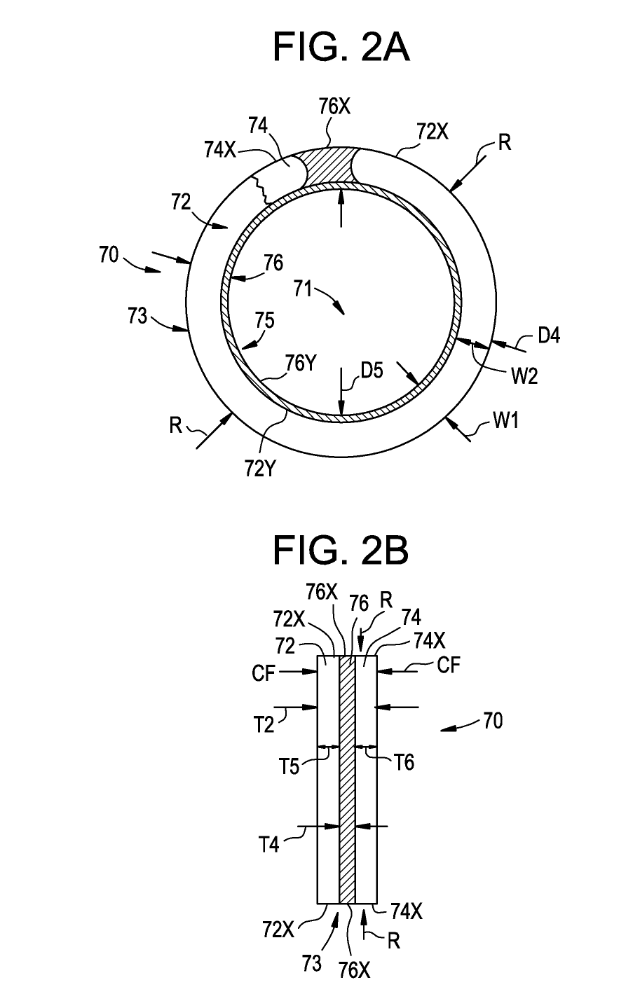

As shown in FIG. 2A, the first composite annular seal assembly 70 is generally annular and defines a bore 71 extending therethrough. At least a portion of the inner race 30 extends through the bore 71 as shown in FIG. 1. The first composite annular seal assembly 70 includes a first annular retaining ring 72 and a second annular retaining ring 74. The first and second annular retaining ring 72, 74 are generally annular, have a bore extending therethrough, and are often referred to as “seal caps.”

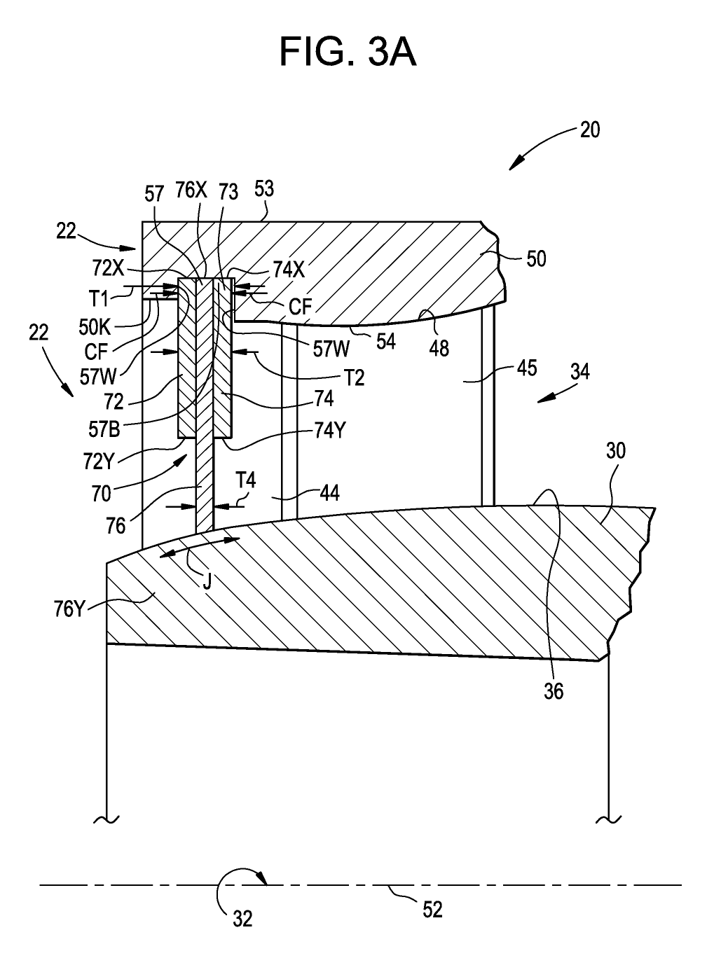

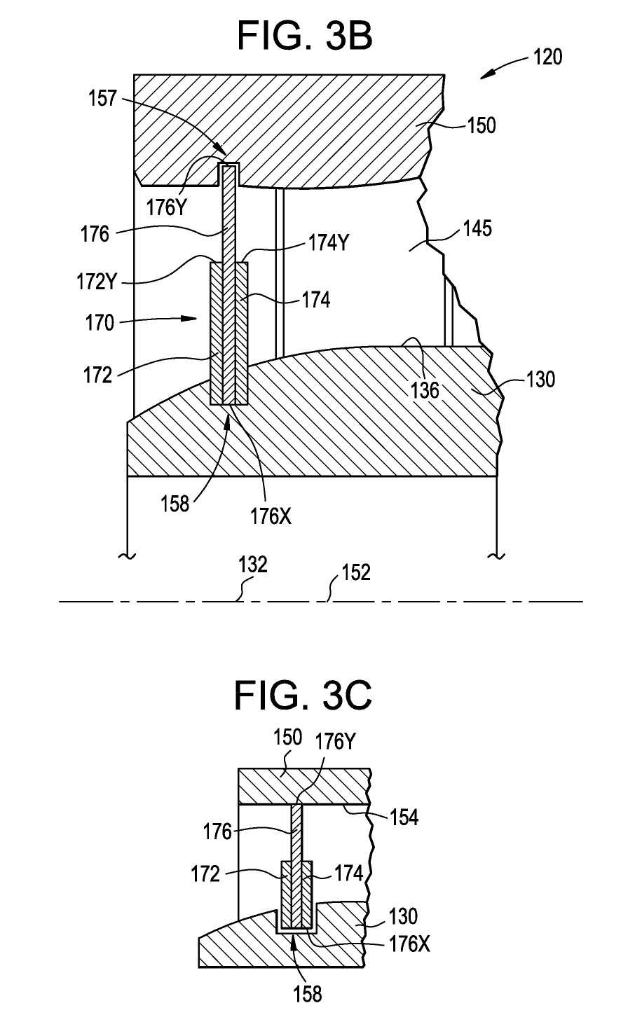

Referring to FIGS. 1 and 2B, the resilient ring 76 is disposed, i.e. sandwiched, between the first annular retaining ring 72 and the second annular retaining ring 74. In the front view of the composite annular seal 70 of FIG. 2A a portion of the first annular retaining ring 72 is shown cut away to illustrate the resilient ring 76 positioned thereunder. In FIG. 2A a portion of the resilient ring 76 is cut away to illustrate the second annular retaining ring 74 thereunder. As shown in FIGS. 2A, 2B and 3A. The composite annular seal assembly 70 defines an outer radial end 73 defined by a first radially outermost portion 72X of the first annular retaining ring 72, a second radially outermost portion 74X of the second annular retaining ring 72 and a third radially outermost portion 76X of the resilient ring 76. The first radially outermost portion 72X of the first annular retaining ring 72, the second radially outermost portion 74X of the second annular retaining ring 72 and the third radially outermost portion 76X are aligned with one another at the outer radial end 73.

As best shown in FIGS. 1, 2A and 3A, the resilient ring 76 extends from the third radially outermost portion 76X radially inward to an inner radial end 76Y. The inner radial end 76Y is positioned radially inward from an inner radial end 72Y of the first annular retaining ring 72 and is positioned radially inward from an inner radial end 74Y of the second annular retaining ring 74. In one embodiment the resilient ring 76 has a width W1 and the first annular retaining ring 72 and the second annular retaining ring 74 each have a width W2. The width W2 is less than the width W1. In one embodiment, the width W2 is between about 70 percent and 90 percent of the width W1.

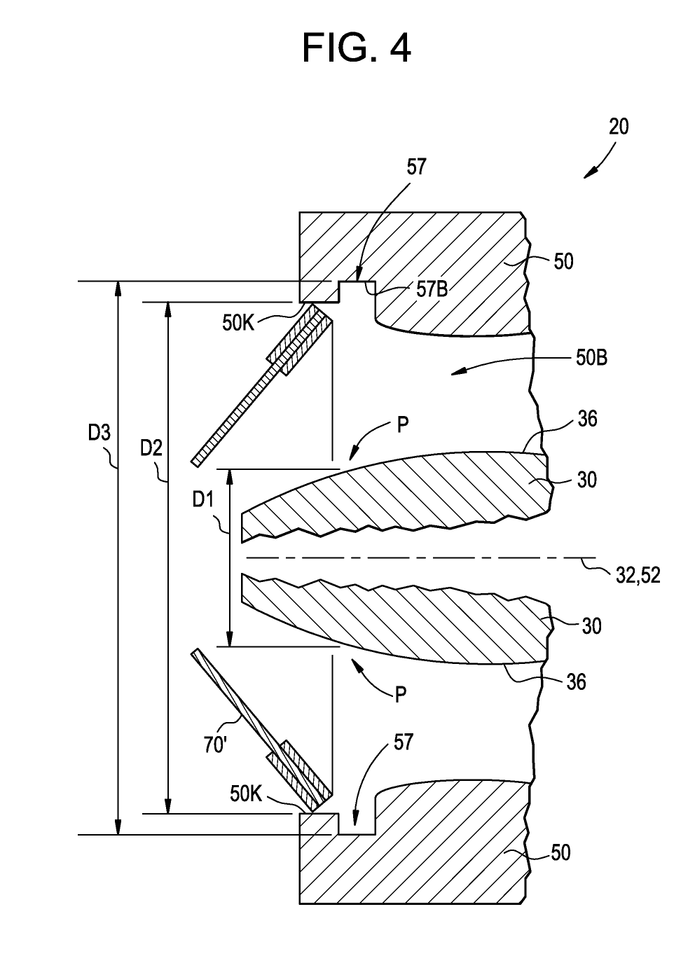

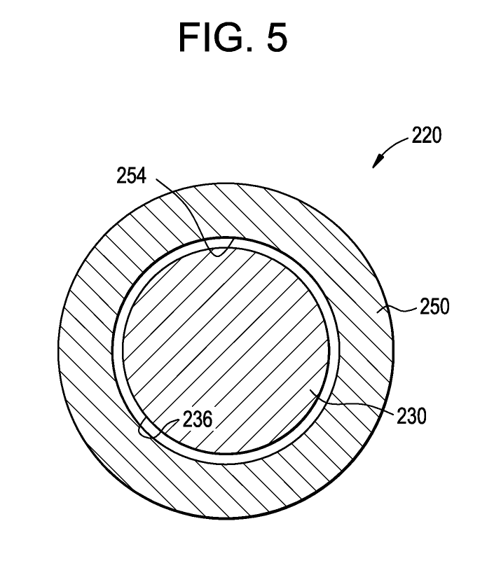

As shown in FIG. 1, the first end 73 of the composite annular seal assembly 70 is received in a radially inward facing groove 57 defined in the outer race 50 adjacent to or proximate the first outer race surface 54 and a lip 50K (see FIG.3) located at the first end 22 of the bearing 20. In the embodiment shown in FIG. 1, the groove 57 defines a channel width T1. The groove is defined by opposing side walls 57W and a base 57B extending between the opposing side walls 57W, as shown in FIG. 3A. As best shown in FIG. 2B, the first end 73 of the composite annular seal assembly 70 defines a thickness T2, wherein T2 includes a thickness T5 of the first annular retaining ring 72, a thickness T6 of the second annular retaining ring 74 and a thickness T4 of the resilient ring 76. In one embodiment, T1 is greater than T2 to allow the first end 73 of the seal 70 to be snap-fit and retained in the groove 57 between the side walls 57W. The snap-fit is accomplished by laterally deflecting the composite annular seal 70 so that the first end 73 thereof is deflected radially inward to clear the lip 50KL and allow the first end 73 to snap into the groove 57, as described further herein with reference to FIG. 4.

While the composite annular seal assembly 70 is described as being seated and secured in the groove 57 using a snap-fit assembly, the present invention is not limited in this regard as other means for securing the composite annular seal assembly 70 in the groove 57, such as for example, installing the first end 73 of the composite annular seal assembly 70 in the groove 57 by using an adhesive, or some other known means, may be used without departing from the broader aspects of the invention.

The inner radial end 76Y of the resilient ring 76 slidingly engages (i.e., laterally and circumferentially) the inner race surface 36 of the inner race 30 adjacent to the first end 22 of the bearing 20 when the first composite annular seal assembly 70 is received in the groove 57 and the inner race 30 is disposed in the outer race 50. As described above, the first end 73 of the composite annular seal assembly 70 is received in the radial groove 57 defined in the outer race 50. As a result, the resilient ring 76 and the first and second retainers 72, 74 are axially secured inside the groove 57. The composite annular seal assembly 70 exhibits a tolerance stack-up such that retention inside the groove 57 by additional means is not necessary. However, use of such additional means for axial retention of the resilient ring 76 and the first and second annular retaining rings 72, 74 inside the groove 57, such as use of adhesives, is considered within the scope of the invention. Similarly, the resilient ring 76 is retained between the first and second annular retaining ring 72 and 74 by the press fit inside the groove 57 such that additional means is not necessary. However, use of such additional means for retaining the resilient ring 76 between the first and second annular retaining ring 72 and 74, such as us of adhesives or mechanical fasteners, is considered within the scope of the invention.

The resilient ring 76 is more compressible and flexible than the first annular retaining ring 72 and the second annular retaining ring 74. For example, resilient ring 76 is made from polytetrafluoroethylene (PTFE) and the first annular retaining ring 72 and the second annular retaining ring 74 are metallic. In one embodiment the first annular retaining ring 72 and the second annular retaining ring 74 are manufactured from a metal sheet stock, for example, stainless steel sheet stock and plain carbon steel sheet stock. However, the present invention is not limited in this regard as any materials may be used for the resilient ring 76, the first annular retaining ring 72 and the second annular retaining ring 74 without departing from the broader aspects disclosed herein.

Depending on the size of the bearing 20, the thickness T4 of the resilient ring 76 is between about 0.010 inch and about 0.064 inch. In one embodiment, the thickness T5 of the first annular retaining ring 72 and the thickness T6 of the second annular retaining ring 74 are each about 0 0.008 inch to about 0.063 inch.

The second composite annular seal assembly 80 is similar in design and construction to the first composite annular seal assembly 70, and is therefore not described in detail herein. Although the hourglass bearing is shown as having a first raceway 44 and a second raceway 46, the present invention is not limited in this regard, and the composite annular seal assembly in accordance with the present invention may by employed on an hourglass roller bearing having only a single row of rollers. It has been discovered that the benefit of the disclosed composite annular seal assembly design is that it facilitates the oscillatory movement of the bearing 20, while remaining stable and in position.

Referring to FIG. 4, the groove 57 has a diameter D3 measured between opposing base portions 57B. A diameter D1 is defined between points of contact P of the inner radial end 76Y of the resilient seal 76 with the inner race surface 36. The outer race 50 defines the lip 50K axially outward from the groove 57. The lip 50K defines a bore 50B having a diameter D2. As shown in FIG. 2A, the composite annular seal assembly 70 has an outside diameter D4 and the resilient ring 76 has an inside diameter D5. In one embodiment, the diameter D2 of the bore 50B is less than the diameter D4 of the composite annular seal assembly 70 to allow the composite annular seal assembly 70 to be laterally elastically deformed, for example, by laterally deflecting the composite annular seal 70 into a deflected state as indicated by element number 70′ in FIG.4 so that the first end 73 thereof is deflected radially inward to clear the lip 50K and allow the first end 73 to be snap-fit into the groove 57. While the composite annular seal assembly 70 is shown and described as being seated in a portion of the outer race 50 and slidingly engaging the inner race 30, and having the resilient ring 76 extending from the third radially outermost portion 76X radially inward to an inner radial end 76Y, the inner radial end 76Y being positioned radially inward from an inner radial end 72Y of the first annular retaining ring 72 and being positioned radially inward from an inner radial end 74Y of the second annular retaining ring 74, the present invention is not limited in this regard. For example, the composite annular seal 170 of FIG. 3B may be employed. The bearing 120 and composite annular seal 170 of FIG. 3B are similar to the bearing 20 and composite annular seal 70 of FIG. 3A, therefore like elements are assigned like reference numbers preceded by the numeral 1. The resilient ring 176 extends from a radially inner most portion 176X radially outward to an outer radial end 176Y. The outer radial end 176Y is positioned radially outward from an outer radial end 172Y of the first annular retaining ring 172 and is positioned radially outward from an outer radial end 174Y of the second annular retaining ring 174. The composite annular seal 170 is seated in the groove 158 and the radially outer most portion 176Y of the resilient ring 176 slidingly engages in the groove 157. In one embodiment, the composite annular seal has a radial slit therein, for example, across the first annular retaining ring 172, the second annular retaining ring 174 and/or the resilient ring 176, to facilitate installation into the groove 158. The composite annular seal 170 is similar to the composite annular seal 70 shown and described herein with regard to thickness and materials. While the radially outer most portion 176Y of the resilient ring 176 is shown and described as slidingly engaging the groove 157, the present invention is not limited in this regard as the groove 157 may be eliminated and the radially outer most portion 176Y of the resilient ring 176 may slidingly engage the outer race surface 154, as shown in FIG. 3C.

While the present disclosure has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A seal for a bearing, the seal comprising:
a first annular retaining ring defining a first radially outermost portion;
a second annular retaining ring defining a second radially outermost portion; and
a resilient ring defining a third radially outermost portion, the resilient ring being disposed between the first annular retaining ring and the second annular retaining ring;
the first radially outermost portion, the second radially outermost portion and the third radially outermost portion being aligned with one another;
the resilient ring projecting radially inward from the first annular retaining ring and the second annular retaining ring; and
the resilient ring being more compressible and flexible than the first annular retaining ring and the second annular retaining ring.

2. The seal according to claim 1, wherein a portion of the resilient ring proximate the third radially outermost portion is retained between a portion of the first annular retaining ring proximate the first radially outermost portion and a portion of the second annular retaining ring proximate the second radially outermost portion in response to retention forces applied to the first annular retaining ring and the second annular retaining ring.

3. The seal according to claim 1, wherein the resilient ring comprises polytetrafluoroethylene.

4. The seal according to claim 1, wherein the first annular retaining ring and the second annular retaining ring comprise metal.

5. A bearing comprising:
an outer race having a first inner surface and an interior area;
an inner race having an outer surface, a portion of the inner race being disposed in the interior area;
an annular seal assembly snap-fit into the outer race, the annular seal assembly comprising:
a first annular retaining ring defining a first radially outermost portion;
a second annular retaining ring defining a second radially outermost portion; and
a resilient ring defining a third radially outermost portion, the resilient ring being disposed between the first annular retaining ring and the second annular retaining ring;
the first radially outermost portion, the second radially outermost portion and the third radially outermost portion being aligned with one another;
the resilient ring projecting radially inward from the first annular retaining ring and the second annular retaining ring; and
the resilient ring being more compressible and flexible than the first annular retaining ring and the second annular retaining ring.

6. The bearing according to claim 5, further comprising:
a radially inward facing groove formed proximate an axial end of the outer race, the groove being defined by opposing side walls and a base extending between the opposing side walls; and
a portion of the first annular retaining ring proximate the first radially outermost portion, a portion of the second annular retaining ring proximate the second radially outermost portion and a portion of the resilient ring proximate the third radially outermost portion being seated between the opposing side walls so that portion of the first annular retaining ring proximate the first radially outermost portion is compressed between the portion of the second annular retaining ring proximate the second radially outermost portion and the portion of the resilient ring proximate the third radially outermost portion, in response to retention forces applied by the opposing side walls to the first annular retaining ring and the second annular retaining ring.

7. The bearing according to claim 5, further comprising:
a plurality of first hourglass rollers, each of the plurality of first hourglass rollers having a generally concave outer surface, the plurality of first hourglass rollers being disposed between the inner race and the outer race;
the first inner surface being convex and the outer surface being convex; and
each of the plurality of first hourglass rollers engaging the outer surface and the first inner surface.

8. The bearing according to claim 7, further comprising:
a second inner surface defined by the outer race, the second inner surface being convex;
a plurality of second hourglass rollers, each of the plurality of second hourglass rollers having a generally concave outer surface, the plurality of second hourglass rollers being disposed between the inner race and the outer race; and
each of the plurality of second hourglass rollers engaging the outer surface and the second inner surface.

9. The bearing according to claim 5, wherein a radially inner end of the resilient ring slidingly engages a portion of the inner race.

10. The bearing according to claim 5, further comprising:
a circumferential groove formed in a radially outward facing surface of the inner race; and
the resilient ring slidingly engages the groove.

11. The bearing according to claim 5, the annular seal assembly is radially compressed between the inner race and the outer race.

12. The bearing according to claim 5 wherein the resilient ring comprises polytetrafluoroethylene.

13. The bearing according to claim 5 wherein the first annular retaining ring and the second annular retaining ring comprise metal.

14. The bearing according to claim 6, wherein the compressive forces are of a magnitude sufficient to retain the annular seal assembly secured to the outer race upon cyclic angular displacement of the outer race relative to the inner race.
